(19) United States
(12) Patent Application Publication
(10) Pub. No.: US 2026/0196070 A1
(43) Pub. Date: Jul. 9, 2026

(54) HANDWRITING RECOGNITION USING EXTRACTED TRAJECTORY INFORMATION

(71) Applicant: INTERNATIONAL BUSINESS MACHINES CORPORATION, ARMONK, NY (US)

(72) Inventors: PARIJAT DUBE, YORKTOWN HEIGHTS, NY (US); UMANG SHARMA, NEW YORK, NY (US); SAURABH GOYAL, JERSEY CITY, NJ (US); ASHISH VERMA, NANUET, NY (US)

(21) Appl. No.: 19/009,223

(22) Filed: Jan. 3, 2025

(51) Int. Cl. G06V 30/32

(52) U.S. Cl. CPC G06V 30/333

(57) ABSTRACT

Handwriting recognition using extracted trajectory information, including: generating, from an image of hand-written text, trajectory data for the hand-written text using a first machine learning model that provides, as output, the trajectory data; aligning, using a software module, the trajectory data with image data of the image to generate an aligned data set; and inputting the aligned data set into a second machine learning model that, in response, provides, as output, machine-readable encoding that represents the hand-written text.

### BACKGROUND

The present disclosure relates to machine learning models and artificial intelligence for performing handwriting recognition and optical character recognition.

### SUMMARY

According to embodiments of the present disclosure, various methods, apparatus and products for handwriting recognition using extracted trajectory information are described herein. In some aspects, handwriting recognition using extracted trajectory information includes generating, from an image of hand-written text, trajectory data for the hand-written text using a first machine learning model that provides, as output, the trajectory data; aligning, using a software module, the trajectory data with image data of the image to generate an aligned data set; and inputting the aligned data set into a second machine learning model that, in response, provides, as output, machine-readable encoding that represents the hand-written text. In some aspects, a computer system may include a processor set; one or more computer-readable storage media; and program instructions stored on the one or more storage media to cause the processor set to perform operations comprising this method. In some aspects, a computer program product may include: one or more computer readable storage media; and program instructions stored on the one or more storage media to perform operations comprising this method.

### BRIEF DESCRIPTION OF THE DRAWINGS

FIG. 1 sets forth an example computing environment for handwriting recognition using extracted trajectory information in accordance with some embodiments of the present disclosure.

FIG. 2 sets forth an example process flow for handwriting recognition using extracted trajectory information in accordance with some embodiments of the present disclosure.

FIG. 3 sets forth an example diagram for generating trajectory data from a handwriting image for handwriting recognition using extracted trajectory information according to some embodiments of the present disclosure.

FIG. 4 sets forth an example diagram for implicit alignment of trajectory and image data for handwriting recognition using extracted trajectory information in accordance with some embodiments of the present disclosure.

FIG. 5A sets forth an example diagram for explicit alignment of trajectory and image data for handwriting recognition using extracted trajectory information in accordance with some embodiments of the present disclosure.

FIG. 5B sets forth an example diagram for explicit alignment of trajectory and image data for handwriting recognition using extracted trajectory information in accordance with some embodiments of the present disclosure.

FIG. 6 sets forth a flowchart of an example method of handwriting recognition using extracted trajectory information in accordance with some embodiments of the present disclosure.

FIG. 7 sets forth a flowchart of another example method of handwriting recognition using extracted trajectory information in accordance with some embodiments of the present disclosure.

FIG. 8 sets forth a flowchart of another example method of handwriting recognition using extracted trajectory information in accordance with some embodiments of the present disclosure.

FIG. 9 sets forth a flowchart of another example method of handwriting recognition using extracted trajectory information in accordance with some embodiments of the present disclosure.

FIG. 10 sets forth a flowchart of another example method of handwriting recognition using extracted trajectory information in accordance with some embodiments of the present disclosure.

### DETAILED DESCRIPTION

Machine learning models may be used to perform handwriting recognition, whereby hand-written text captured by an image is converted into a machine-readable encoding of the text. Some “offline” approaches require only an image of hand-written text for handwriting recognition while some “online” approaches use trajectory information describing the movement of a writing utensil when creating the hand-written text. These online approaches generally have higher accuracy than their offline counterparts but require trajectory information gathered through real-time monitoring of a handwriting utensil. Accordingly, existing implementations do not allow for higher-accuracy online models to be used for handwriting recognition in the absence of trajectory information gathered through real-time monitoring.

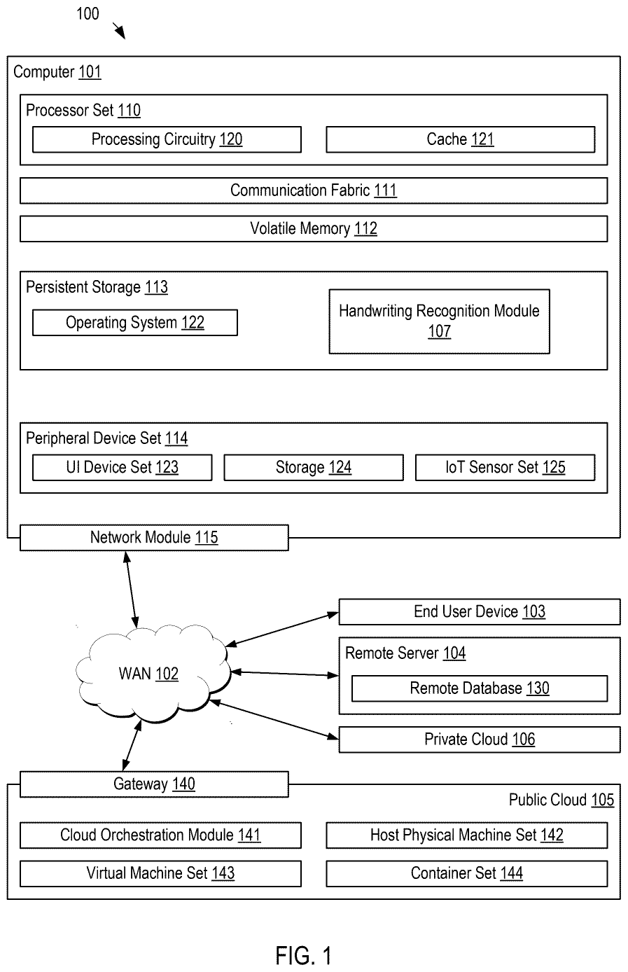

With reference now to FIG. 1, shown is an example computing environment according to aspects of the present disclosure. Computing environment 100 contains an example of an environment for the execution of at least some of the computer code involved in performing the various methods described herein, such as a handwriting recognition module 107. In addition to the handwriting recognition module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the handwriting recognition module 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in the handwriting recognition module 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in the handwriting recognition module 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

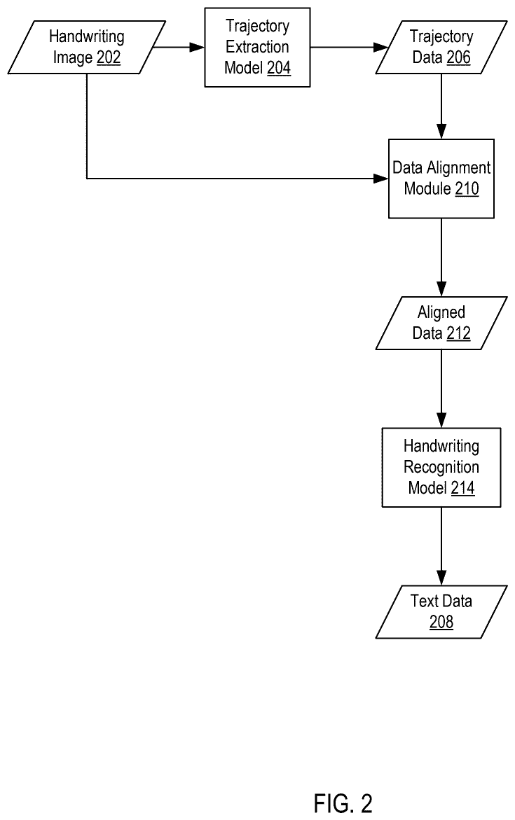

FIG. 2 sets forth an example process flow for handwriting recognition using extracted trajectory information in accordance with some embodiments of the present disclosure. To begin, a handwriting image 202 is provided as input to a trajectory extraction model 204 to generate trajectory data 206 from the handwriting image 202. The handwriting image 202 is image data (e.g., an encoding of an image) capturing hand-written text to be converted into text data 208 using the approaches set forth herein. For example, in some embodiments, the handwriting image 202 may include a photograph or scanned image capturing a physical object including hand-written text, such as a document. As another example, in some embodiments, the handwriting image 202 may include a computer-generated image capturing handwritten text created using an input device such as a touchscreen, a touchpad, a tablet, and the like. The text data 208 is a machine-readable encoding of the hand-written text, such as a string encoding or another text encoding as can be appreciated. In other words, the approaches set forth herein serve to apply handwriting recognition to the hand-written text of the handwriting image 202 to produce the text data 208.

The trajectory extraction model 204 is a trained machine learning model that accepts, as input, handwriting images 202 and provides, as output, trajectory data 206. Particular approaches for training and using the trajectory extraction model 204 will be described in further detail below. The trajectory data 206 describes the placement and/or movement of a writing utensil (e.g., a pen, a pencil, a computer input device). In some embodiments, the trajectory data 206 may be encoded as a sequence of tuples each including three elements (xₜ, yₜ, eₜ), where x is an X coordinate, y is a Y coordinate, e is a stroke end flag, and t is a time or sequence number in the sequence. The X and Y coordinates, in combination, correspond to a point in a grid through which the writing utensil passes, such as the grid of pixels encoding the handwriting image 202. The stroke end flag indicates whether the writing utensil was lifted at the corresponding point, thereby denoting whether the corresponding point should be linked to the next point in the sequence (e.g., due to being part of the same handwriting stroke), e.g., should be linked to an immediately subsequent point of the hand-written text, or was not linked to the immediately subsequent point due to the writing utensil having been lifted up during the writing.

The trajectory data 206 is then aligned with data from the handwriting image 202 using a data alignment module 210. Alignment of data across different modalities serves to correlate or associate portions of data from one modality that are related to another. Here, aligning the trajectory data 206 with data from the handwriting image 202 serves to determine which portions of the handwriting image 202 are related to which portions of the trajectory data 206. Accordingly, the aligned data 212 produced by the data alignment module 210 indicates or describes the relationships between trajectory data 206 and data from the handwriting image 202. As will be described in further detail below, the data alignment module 210 may be implemented using various approaches, including using different trained machine learning models, data correlation or alignment techniques, and the like.

The aligned data 212 is then provided, as input, to a handwriting recognition model 214 that produces, as output, the text data 208. The handwriting recognition model 214 may include any machine learning model trained to perform handwriting recognition using combinations of both image data and trajectory data 206, including preexisting handwriting recognition models 214 or new, specifically trained handwriting recognition models 214. Readers will appreciate handwriting recognition models 214 that use trajectory data 206 to perform handwriting recognition have greater accuracy than other models that only use image data (e.g., data included in or generated from a handwriting image 202). However, existing implementations require that trajectory data 206 be generated by tracking the movement of a writing utensil as it is used to create the handwritten text, and therefore cannot be used where only a handwriting image 202 is available. Instead, the approaches set forth herein are directed to aligning image data with trajectory data 206 extracted from the handwriting image 202, allowing the aligned data 212 to be compatible with existing handwriting recognition models 214 that use trajectory data 206 for handwriting recognition. This aligning and compatibility improves the accuracy of the resulting text data 208, improving overall system utility.

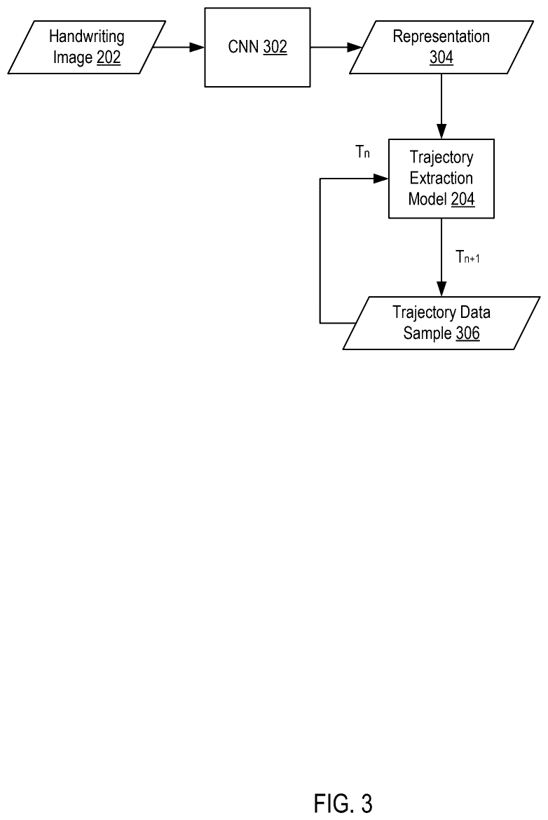

FIG. 3 sets forth an example diagram for generating trajectory data 206 from a handwriting image 202 for handwriting recognition using extracted trajectory information according to some embodiments of the present disclosure. Here, the handwriting image 202 is provided as input to a convolutional neural network (CNN) 302 that, in response, provides, as output an encoded representation of the handwriting image 202, shown as a representation 304. The representation 304 is a multidimensional numerical encoding of the handwriting image 202, such as a multidimensional vector. Accordingly, in some embodiments, the representation 304 may include a vector embedding of the handwriting image 202. In some embodiments, the representation 304 may include a latent space representation of the handwriting image that maps the handwriting image 202 to a latent space of lower dimensionality.

The representation 304 is then used to initialize a hidden state of the trajectory extraction model 204. In some embodiments, the trajectory extraction model 204 may include a sequence prediction model: a trained machine learning model that generates predicted sequences of outputs that accepts, as input for generating a given portion of a sequence, one or more previous portions of the sequence (e.g., previously predicted portions of the sequence). In some embodiments, the trajectory extraction model 204 may include a transformer or other sequence prediction model as can be appreciated. For example, in order to generate the next trajectory data sample 306 of a sequence for time Tₙ₊₁ the trajectory extraction model 204 accepts, as input, the previously generated trajectory data sample 306 for time Tₙ. Here, the representation 304 is used to initialize a hidden state of the trajectory extraction model 204, allowing the trajectory extraction model 204 to produce trajectory data samples 306 using the hidden state. The iteration of producing data samples occurs until the representation 304 is passed completely through. Passing through all of the representation 304 for the iterations represents examining all of the word portion of the handwriting image 202.

In some embodiments, the trajectory extraction model 204 may be trained using a data set that associates image data of handwriting samples with corresponding trajectory data 206. For example, a public data set such as the IAMOnline data set may be used as training data for the trajectory extraction model 204. Other data sets associating image data of handwriting samples with corresponding trajectory data 206 may also be used in training the trajectory extraction model 204.

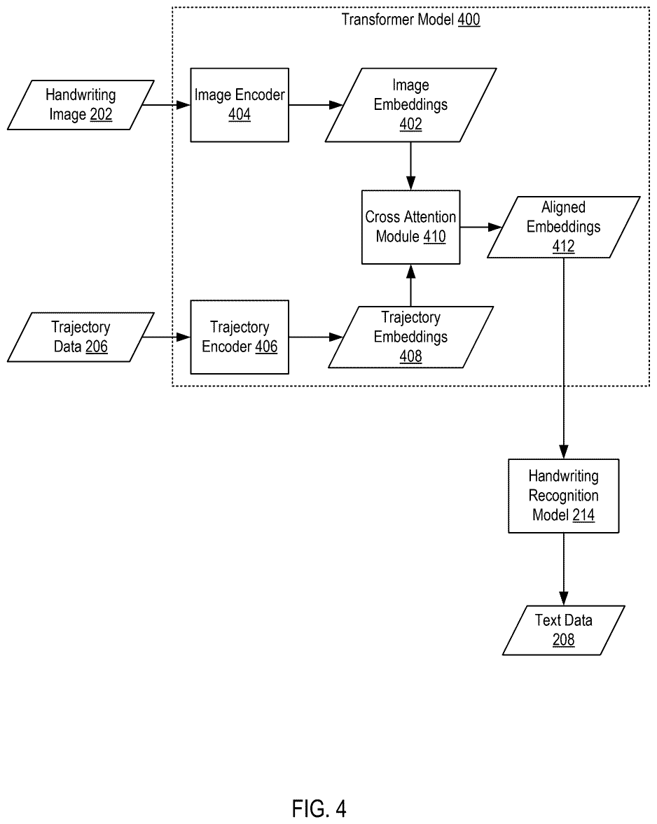

FIG. 4 sets forth an example diagram for implicit alignment of trajectory and image data for handwriting recognition using extracted trajectory information in accordance with some embodiments of the present disclosure. In some embodiments, implicit alignment of the trajectory and image data may be performed using a transformer model 400 or other machine learning model as can be appreciated. To begin, image embeddings 402 are generated from a handwriting image 202 using an image encoder 404 (e.g., of the transformer model 400). The image embeddings 402 may include one or more multidimensional numerical encodings, such as vector embeddings, based on the handwriting image 202 or a portion of the handwriting image 202.

For example, in some embodiments, the handwriting image 202 may be subdivided into multiple regions and an image embedding 402 may be generated for each region. Each region may include, for example, a region of a fixed size, a region bounding a particular object such as a letter or work, or other regions as can be appreciated. Continuing with this example, in some embodiments, the handwriting image 202 may be subdivided into multiple regions to form a sequence of regions ordered based on the direction in which the handwritten text is read (e.g., from left to right). In some embodiments, the image encoder 404 may be implemented as an embedding layer of the transformer model 400, a trained neural network, or other machine learning model as can be appreciated. In some embodiments, the image encoder 404 may be trained such that the resulting image embeddings 402 capture or emphasize particular features relevant or related to handwriting recognition.

The trajectory data 206 is provided as input to a trajectory encoder 406 to generate trajectory embeddings 408. The trajectory embeddings 408 are multidimensional numerical encodings, such as vector embeddings, each based on a corresponding portion of the trajectory data 206. In some embodiments, the trajectory encoder 406 may include a trained neural network such as a CNN, or other machine learning model as can be appreciated. In some embodiments, the trajectory encoder 406 may be trained such that the resulting trajectory embeddings 408 capture or emphasize particular features relevant or related to handwriting recognition. In some embodiments, the trajectory encoder 406 may generate trajectory embeddings 408 by sequentially processing the trajectory data 206 such that the trajectory embedding 408 for a given portion of trajectory data 206 may be generated based on the trajectory embeddings 408 for previously generated, sequentially preceding, e.g., sequentially immediately preceding, portions of trajectory data 206.

The cross attention module 410 applies cross attention to the image embeddings 402 and the trajectory embeddings 408. As would be understood by one skilled in the art, transformers such as the transformer model 400 may use cross attention to capture relationships between elements of different sequences. Here, cross attention may be used to capture relationships between regions of the handwriting image and portions of trajectory data 206 using their respective embeddings. In other words, cross attention heads of the transformer model 400 may be used to align the trajectory embeddings 408 with the image embeddings 402.

Cross attention includes generating, from embeddings of one sequence, a key vector and a value vector and, from embeddings of the other sequence, query vectors. Each key, query, and value vector may be generated from a corresponding embedding by applying a linear transformation to the corresponding embedding. For example, for each image embedding 402, a corresponding key vector and value vector may be generated while, for each trajectory embedding 408, a corresponding query vector may be generated. Next, a similarity or “attention” score is calculated for each pair of query vectors and key vectors. The similarity score for a pair of vectors may be calculated using a variety of approaches as can be appreciated, such as a dot product or another function.

As an example, assuming a given query embedding for a trajectory embedding 408, similarity scores may be calculated for the key vectors of each image embedding 402. The similarity scores for a given key vector may then be used as a weight applied to its corresponding value vector. A final embedding for the trajectory embedding 408 may then be calculated as a function of the weighted value vectors for each image embedding 402. This may be repeated for each trajectory embedding 408 to generate a final set of trajectory embeddings 408. In some embodiments, this process may again be repeated, instead using key and value vectors for trajectory embeddings 408 and query vectors for image embeddings 402 to generate final embeddings for the image embeddings 402. The final embeddings for the trajectory embeddings 408 and the image embeddings 402 may then be combined using a pooling layer or concatenation as would be understood by one skilled in the art. The combined embeddings, shown as aligned embeddings 412, may then be used by the handwriting recognition model 214 to generate the text data 208.

In some embodiments, the transformer model 400, including the various components described above, may be trained using contrastive loss. Training using contrastive loss causes embeddings known to be related (e.g., known related image embeddings 402 and trajectory embeddings 408) to be closer in multidimensional space and embeddings known to be unrelated to be further apart. As is set forth above, the trajectory extraction model 204 can be trained using a data set, such as the IAMOnline data set, that associates handwriting image data with corresponding trajectory information. Such a data set may be used to train the transformer model 400. For example, a positive training data sample may be generated using image data from an entry in the data set and corresponding trajectory information from that entry. As the image data and trajectory information are known to be related, the transformer model 400 may be trained such that their respective embeddings are closer together. A negative training data sample may be generated using image data and trajectory information from randomly selected, different entries. As the image data and trajectory information are known to be unrelated due to coming from different entries, the transformer model 400 may be trained such that their respective embeddings are further apart.

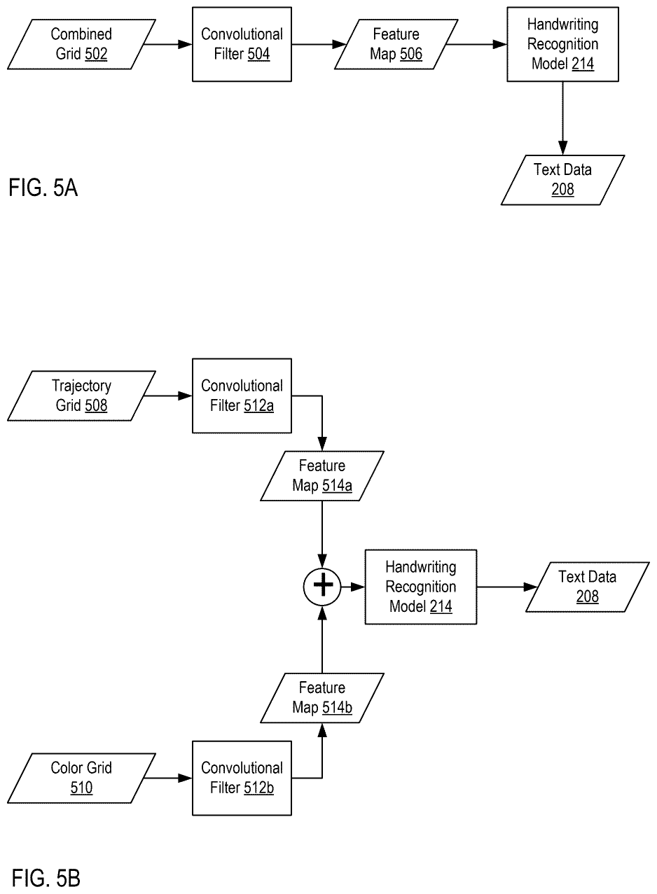

FIGS. 5A and 5B set forth respective example diagrams for explicit alignment of trajectory and image data for handwriting recognition using extracted trajectory information in accordance with some embodiments of the present disclosure. Explicit alignment correlates the trajectory and image data on a per-pixel basis, correlating each portion of trajectory data 206 with data of the corresponding pixels in the handwriting image 202. For example, FIG. 5A shows a combined grid 502 that encodes, in the same data set that includes a grid of coordinates or pixels of the handwriting image 202 as well as additional data, both image data from the handwriting image 202 and trajectory data 206. For example, the combined grid 502 may include multiple pixels each including both color information and trajectory information. Continuing with this example, each pixel may be encoded using five values or channels: three color values (e.g., RGB), a stroke end flag, and a sequence number in the sequence of trajectory data 206. Readers will appreciate that, where a particular pixel is not included in the handwritten text, the stroke end flag and/or the sequence number may be set to a particular value indicating as such (e.g., zero or a negative value). Moreover, readers will appreciate that the particular number of color values may vary depending on the particular encoding of the image data.

In some embodiments, the combined grid 502 is provided as input to a convolutional filter 504. A convolutional filter 504 is used to identify patterns or features in an input image and, in response to receiving the input image, provide, as output, a reduced dimension matrix called a feature map 506. Here, the combined grid 502 may be treated as a multi-channel image (e.g., of five channels using the example above). The feature map 506 may then be provided as input to the handwriting recognition model 214 to produce text data 208.

Turning now to FIG. 5B, rather than encoding image and trajectory information in the same combined grid 502, the trajectory information and image data are encoded as separate grids of coordinates or pixels. The trajectory information is encoded as a trajectory grid 508 while image data is encoded in a color grid 510. The color grid 510 may include the handwriting image 202 or a derivative thereof, with each coordinate or pixel encoding color information as described above (e.g., using three channels such as RGB). The trajectory grid 508 includes, for each coordinate or pixel value, two channels of trajectory information as described above: a stroke end flag and a sequence number in the sequence of trajectory data 206.

Here, the trajectory grid 508 and color grid 510 are each provided to respective convolutional filters 512a,b to produce feature maps 514a,b. The feature maps 514a,b are combined by concatenating the values from each feature map 514a,b. The combined feature maps 514a,b are then provided as input to the handwriting recognition model 214 to produce text data 208.

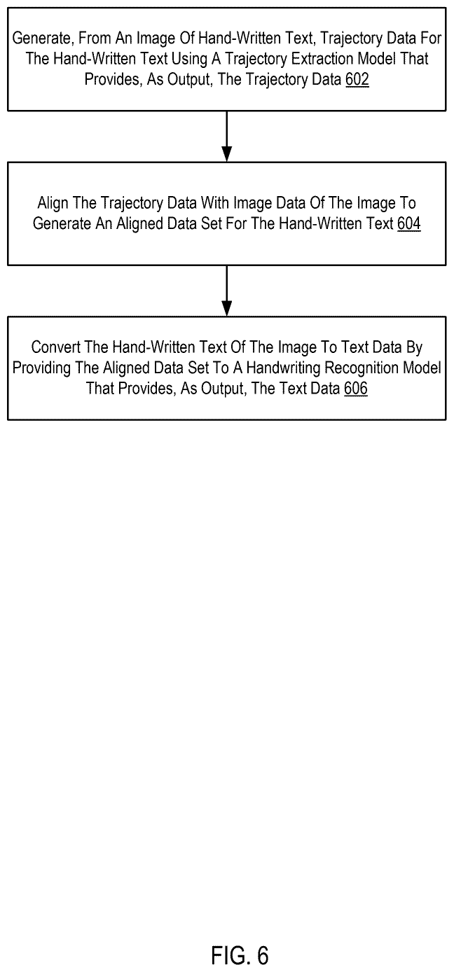

For further explanation, FIG. 6 sets forth a flowchart of an example method of handwriting recognition using extracted trajectory information in accordance with some embodiment of the present disclosure. The method of FIG. 6 may be performed, for example, using the handwriting recognition module 107 of FIG. 1. The method of FIG. 6 includes: generating 602, from an image of hand-written text, trajectory data for the hand-written text using a trajectory extraction model that provides, as output, the trajectory data. In some embodiments, the image may include a scanned or otherwise digitally encoded visual representation of a physical object, such as a document, that includes hand-written text. In some embodiments, the image may include a computer-generated image of handwriting, such as an image encoding of hand-written input to an input device such as a touch screen, tablet, and the like.

In some embodiments, the trajectory extraction model includes a trained model such as a trained neural network or other machine learning model as can be appreciated. Particular approaches for training the trajectory extraction model are described in further detail below. In some embodiments, the trajectory extraction model may include a sequence prediction model that provides, as output, sequential data points, with each sequential data point being based on one or more earlier data points in the sequence.

In some embodiments, the trajectory data describes the placement and/or movement of a writing utensil (e.g., a pen, a pencil, a computer input device) while creating or inputting the hand-written text. In some embodiments, the trajectory data may be encoded as a sequence of tuples each including three elements (xₜ, yₜ, eₜ), where x is an X coordinate, y is a Y coordinate, e is a stroke end flag, and t is a time or sequence number in the sequence. The X and Y coordinates, in combination, correspond to a point in a grid through which the writing utensil passes, such as the grid of pixels encoding the image. The stroke end flag indicates whether the writing utensil was lifted at the corresponding point, thereby denoting whether the corresponding point should be linked to the next point in the sequence (e.g., due to being part of the same handwriting stroke).

The method of FIG. 6 also includes aligning 604 the trajectory data with image data of the image to generate an aligned data set for the hand-written text. Aligning data across different modalities serves to identify relationships between data from one data set and data in another data set. Here, aligning 604 the trajectory data with image data of the image serves to identify or determine what portions of trajectory data are related to or correspond to what portions of image data (e.g., either data of the image itself or derived therefrom). Particular approaches for aligning 604 the trajectory data with image data of the image are described in further detail below. For example, aligning 604 the trajectory data with image data of the image may include implicit alignment using cross attention, explicit alignment of pixel-level or grid-level image and trajectory data, and the like.

The method of FIG. 6 also includes converting 606 the hand-written text of the image to text data by providing the aligned data set to a handwriting recognition model that provides, as output, the text data. Here, the handwriting recognition model may include any trained model for performing handwriting recognition using combinations of image data and trajectory data. As the handwriting recognition model uses both image and trajectory data, the handwriting recognition model is more accurate than other approaches that may only use image data. Readers will appreciate that, as the approaches described herein extract trajectory information from images, this allows for these more accurate models to be used in implementations that previously required active tracking of the movement of a writing utensil in order to generate trajectory information for a handwriting sample.

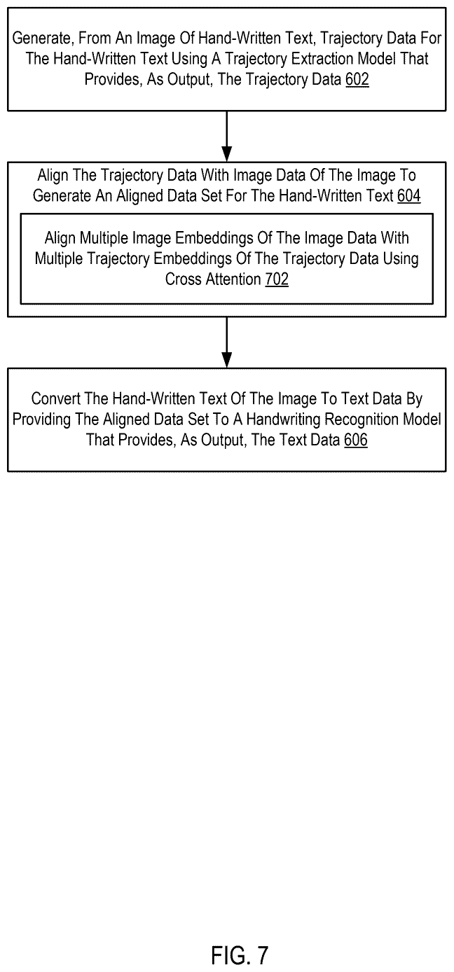

For further explanation, FIG. 7 sets forth a flowchart of another example method of handwriting recognition using extracted trajectory information in accordance with some embodiments of the present disclosure. The method of FIG. 7 is similar to FIG. 6 in that the method of FIG. 7 also includes: generating 602, from an image of hand-written text, trajectory data for the hand-written text using a trajectory extraction model that provides, as output, the trajectory data; aligning 604 the trajectory data with image data of the image to generate an aligned data set for the hand-written text; and converting 606 the hand-written text of the image to text data by providing the aligned data set to a handwriting recognition model that provides, as output, the text data.

The method of FIG. 7 differs from FIG. 6 in that aligning 604 the trajectory data with image data of the image to generate an aligned data set for the hand-written text also includes aligning 702 multiple image embeddings of the image data with multiple trajectory embeddings of the trajectory data using cross attention. This may include, for example, using implicit alignment of the image embeddings and trajectory embeddings as described above. For example, image embeddings may be generated from the image using an image encoder, such as an embedding layer. The image embeddings may include one or more multidimensional numerical encodings, such as vector embeddings, based on the image or portions thereof. Trajectory embeddings may be generated from the trajectory data using a trajectory encoder. In some embodiments, the trajectory encoder may generate trajectory embeddings by sequentially processing the trajectory data such that the trajectory embedding 408 for a given portion of trajectory data may be generated based on the trajectory embeddings 408 for previously generated, sequentially preceding portions of trajectory data.

Cross attention may then be used to align 702 the image embeddings with the trajectory embeddings. For example, key and value vectors may be generated from a first set of embeddings while query vectors may be generated from a second set of embeddings by applying linear projections to the respective sets of embeddings. Similarity or attention scores may then be calculated from pairs of key and query vectors in order to scale value vectors in order to generate final embeddings for the image and/or trajectory embeddings. These final embeddings may then be aligned using a pooling layer or concatenation. In some embodiments, the various components used to generate the embeddings and/or apply cross attention may be trained using contrastive loss to guide related embeddings closer together and unrelated embeddings further apart in multidimensional space.

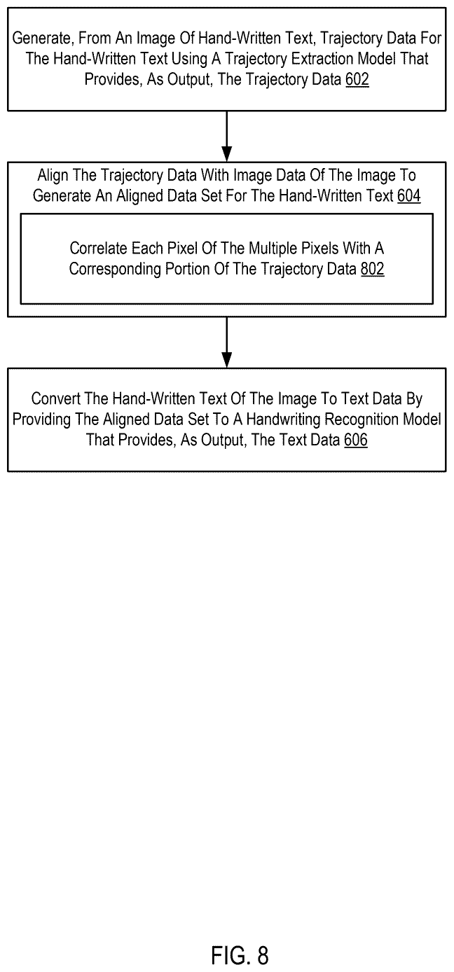

For further explanation, FIG. 8 sets forth a flowchart of another example method of handwriting recognition using extracted trajectory information in accordance with some embodiments of the present disclosure. The method of FIG. 8 is similar to FIG. 6 in that the method of FIG. 8 also includes: generating 602, from an image of hand-written text, trajectory data for the hand-written text using a trajectory extraction model that provides, as output, the trajectory data; aligning 604 the trajectory data with image data of the image to generate an aligned data set for the hand-written text; and converting 606 the hand-written text of the image to text data by providing the aligned data set to a handwriting recognition model that provides, as output, the text data.

The method of FIG. 8 differs from FIG. 6 in that aligning 604 the trajectory data with image data of the image to generate an aligned data set for the hand-written text also includes correlating 802 each pixel of the multiple pixels with a corresponding portion of the trajectory data. This may include, for example, using explicit alignment as described above. For example, in some embodiments, a grid encoding of the image may correlate pixel-level color information with trajectory information such that each pixel or coordinate may include color information values and trajectory information values. This grid encoding may then be passed through a convolutional filter whose output feature map is provided as input to a handwriting recognition model to generate the text data.

As another example, in some embodiments, a first grid encoding may encode, for each pixel or coordinate, color information and a second grid encoding may encode, for each pixel or coordinate, trajectory information. These grid encodings may then be passed through separate convolutional filters to produce a set of feature maps. Values from corresponding coordinates of the feature maps may be concatenated together to produce a combined feature map encoding both color and trajectory information. This combined feature map may then be provided as input to a handwriting recognition model to generate the text data.

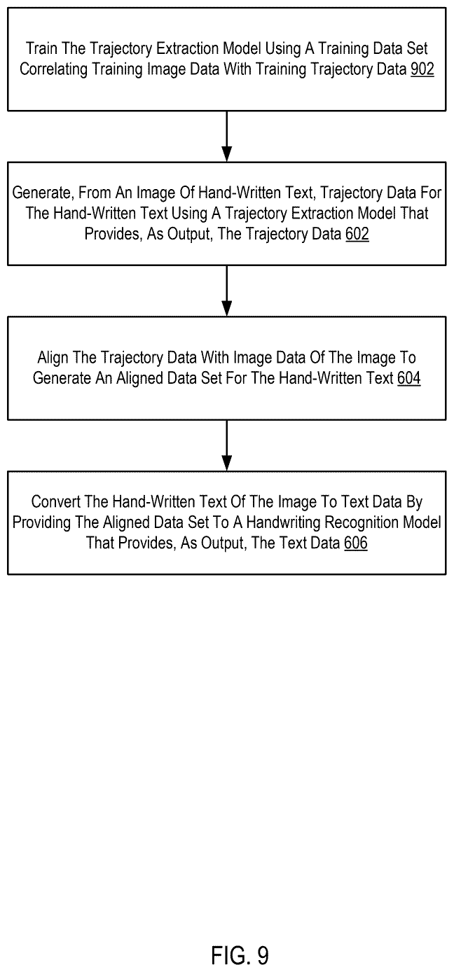

For further explanation, FIG. 9 sets forth a flowchart of another example method of handwriting recognition using extracted trajectory information in accordance with some embodiments of the present disclosure. The method of FIG. 9 is similar to FIG. 6 in that the method of FIG. 9 also includes: generating 602, from an image of hand-written text, trajectory data for the hand-written text using a trajectory extraction model that provides, as output, the trajectory data; aligning 604 the trajectory data with image data of the image to generate an aligned data set for the hand-written text; and converting 606 the hand-written text of the image to text data by providing the aligned data set to a handwriting recognition model that provides, as output, the text data.

The method of FIG. 9 differs from FIG. 6 in that the method of FIG. 9 also includes training 902 the trajectory extraction model using a training data set correlating training image data with training trajectory data. In some embodiments, a data set may include portions of image data capturing handwriting and corresponding trajectory information describing the movement of a writing utensil when creating the corresponding handwriting. This may include, for example, a publicly available or accessible data set such as the IAMOnline data set. This data set may be used as training data for the trajectory extraction model for learning trajectory information from input image data.

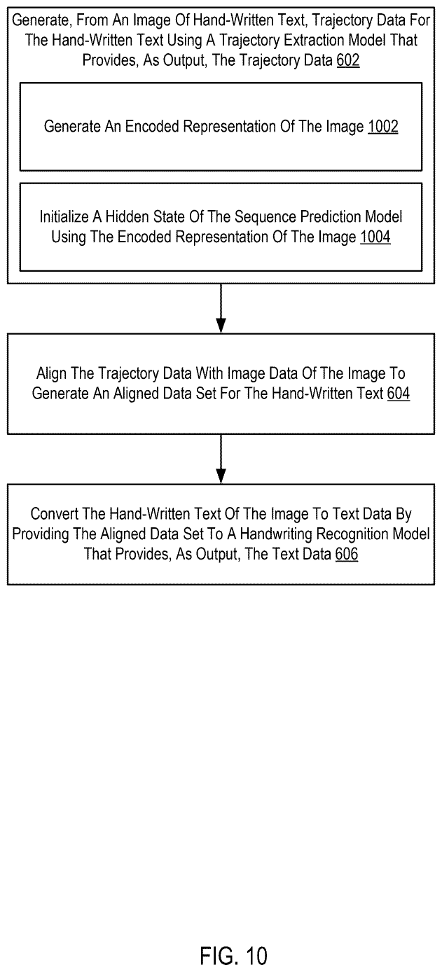

For further explanation, FIG. 10 sets forth a flowchart of another example method of handwriting recognition using extracted trajectory information in accordance with some embodiments of the present disclosure. The method of FIG. 10 is similar to FIG. 6 in that the method of FIG. 10 also includes: generating 602, from an image of hand-written text, trajectory data for the hand-written text using a trajectory extraction model that provides, as output, the trajectory data; aligning 604 the trajectory data with image data of the image to generate an aligned data set for the hand-written text; and converting 606 the hand-written text of the image to text data by providing the aligned data set to a handwriting recognition model that provides, as output, the text data.

The method of FIG. 10 differs from FIG. 6 in that generating 602, from an image of hand-written text, trajectory data for the hand-written text using a trajectory extraction model that provides, as output, the trajectory data also includes generating 1002 an encoded representation of the image. In some embodiments, the encoded representation of the image may include a multidimensional numerical representation of the image, such as a vector embedding. In some embodiments, the encoded representation of the image may include a latent space representation of the image, mapping the image to a lower-dimension multidimensional space that emphasizes or captures particular features of the image. This encoded representation of the image includes a format that may be processed or understood by the trajectory extraction model when generating the trajectory data.

The method of FIG. 10 further differs from FIG. 6 in that generating 602, from an image of hand-written text, trajectory data for the hand-written text using a trajectory extraction model that provides, as output, the trajectory data also includes initializing 1004 a hidden state of the trajectory extraction model using the encoded representation of the image. As is set forth above, in some embodiments, the trajectory extraction model may include a sequence prediction model that generates sequential predictions based on earlier predictions in the sequence. In such embodiments, a hidden layer of the sequence prediction model must be initialized so as to begin producing predictions as output. Accordingly, the hidden layer of the trajectory extraction model is initialized using the encoded representation of the image so as to allow the trajectory extraction model to begin generating sequences of trajectory data.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
generating, from an image of hand-written text, trajectory data for the hand-written text using a first machine learning model that provides, as output, the trajectory data;
aligning, using a software module, the trajectory data with image data of the image to generate an aligned data set; and
inputting the aligned data set into a second machine learning model that, in response, provides, as output, machine-readable encoding that represents the hand-written text.

2. The computer-implemented method of claim 1, wherein the aligning the trajectory data with the image data comprises aligning multiple image embeddings of the image data with multiple trajectory embeddings of the trajectory data using cross attention in a transformer machine learning model of the software module.

3. The computer-implemented method of claim 2, further comprising training the transformer machine learning model using contrastive loss, wherein the transformer machine learning model that performs the aligning comprises the trained transformer machine learning model.

4. The computer-implemented method of claim 1, wherein the image data comprises multiple pixels of the image and wherein the aligning the trajectory data with the image data comprises correlating each pixel of the multiple pixels with a corresponding portion of the trajectory data.

5. The computer-implemented method of claim 4, wherein the aligning comprises performing the correlating to generate a combined grid and inputting the combined grid into a convolutional filter that, in response, produces a feature map that is the aligned data set that is input into the second machine learning model.

6. The computer-implemented method of claim 4, wherein the aligning comprises:
inputting the trajectory data into a first grid;
inputting the image data into a color grid;
inputting the first grid and the color grid separately into one or more convolutional filters so that, in response the one or more convolutional filters output a first feature map and a second feature map, respectively, and
combining the first feature map and the second feature map to produce the aligned data set that is input into the second machine learning model.

7. The computer-implemented method of claim 6, wherein the combining comprises concatenating values of the first feature map and the second feature map to produce the aligned data set that is input into the second machine learning model.

8. The computer-implemented method of claim 1, further comprising training the first machine learning using a training data set that correlates training image data with training trajectory data.

9. The computer-implemented method of claim 1, wherein the first machine learning model comprises a sequence prediction model.

10. The computer-implemented method of claim 9, wherein the generating the trajectory data comprises:
generating an encoded representation of the image; and
initializing a hidden state of the sequence prediction model using the encoded representation of the image.

11. The computer-implemented method of claim 1, wherein the trajectory data comprises stroke end flags corresponding to respective points of the hand-written text, the stroke end flags respectively indicating whether a writing utensil used to write the hand-written text was linked to an immediately subsequent point of the hand-written text or was lifted up at the respective point.

12. A computer system comprising:
a processor set;
one or more computer-readable storage media; and
program instructions stored on the one or more storage media to cause the processor set to perform operations comprising:
generating, from an image of hand-written text, trajectory data for the hand-written text using a first machine learning model that provides, as output, the trajectory data;
aligning, using a software module, the trajectory data with image data of the image to generate an aligned data set; and
inputting the aligned data set into a second machine learning model that, in response, provides, as output, machine-readable encoding that represents the hand-written text.

13. The computer-implemented method of claim 12, wherein the aligning the trajectory data with the image data comprises aligning multiple image embeddings of the image data with multiple trajectory embeddings of the trajectory data using cross attention in a transformer machine learning model of the software module.

14. The computer-implemented method of claim 13, further comprising training the transformer machine learning model using contrastive loss, wherein the transformer machine learning model that performs the aligning comprises the trained transformer machine learning model.

15. The computer-implemented method of claim 12, wherein the image data comprises multiple pixels of the image and wherein the aligning the trajectory data with the image data comprises correlating each pixel of the multiple pixels with a corresponding portion of the trajectory data.

16. The computer-implemented method of claim 15, wherein the aligning comprises performing the correlating to generate a combined grid and inputting the combined grid into a convolutional filter that, in response, produces a feature map that is the aligned data set that is input into the second machine learning model.

17. The computer-implemented method of claim 15, wherein the aligning comprises:
inputting the trajectory data into a first grid;
inputting the image data into a color grid;
inputting the first grid and the color grid separately into one or more convolutional filters so that, in response the one or more convolutional filters output a first feature map and a second feature map, respectively, and
combining the first feature map and the second feature map to produce the aligned data set that is input into the second machine learning model.

18. The computer-implemented method of claim 17, wherein the combining comprises concatenating values of the first feature map and the second feature map to produce the aligned data set that is input into the second machine learning model.

19. The computer-implemented method of claim 12, further comprising training the first machine learning using a training data set that correlates training image data with training trajectory data.

20. A computer program product comprising:
one or more computer-readable storage media; and
program instructions stored on the one or more storage media to perform operations comprising:
generating, from an image of hand-written text, trajectory data for the hand-written text using a trajectory extraction model that provides, as output, the trajectory data;
aligning the trajectory data with image data of the image to generate an aligned data set for the hand-written text; and
converting the hand-written text of the image to text data by providing the aligned data set to a handwriting recognition model that provides, as output, the text data.
